(19) United States
(12) Patent Application Publication
(10) Pub. No.: US 2023/0218018 A1
(43) Pub. Date: Jul. 13, 2023

(54) MASK

(71) Applicant: CHINA SURGICAL DRESSINGS CENTER CO., LTD., Changhua City (TW)

(72) Inventor: JONATHAN TEH CHENG CHANG, HARVARD, MA (US)

(21) Appl. No.: 17/574,889

(22) Filed: Jan. 13, 2022

(51) Int. Cl. A41D 13/11; A62B 18/08; A62B 18/02

(52) U.S. Cl. CPC A41D 13/11; A62B 18/084; A62B 18/025

(57) ABSTRACT

A mask includes a main body. The main body includes a first outer layer, a second outer layer, a middle layer, and an inner layer which are sequentially stacked in a stacking direction. The first outer layer and the second outer layer are non-woven fabrics. The first outer layer includes a plurality of first pressed portions. The second outer layer disposed with a plurality of second pressed portions.

### BACKGROUND OF THE INVENTION

### Field of the Invention

The present invention relates to a mask.

### Description of the Prior Art

In response to the broad spread of pneumonia, influenza and other epidemics in the world, people are becoming more and more accustomed to wearing masks, and thus the demand for masks considerably increases. This will cause a lot of resources and manpower to invest in the production and research and development of masks. The main body of a conventional mask is constructed of three layers. The outer layer of the main body is a water repellent layer capable of blocking liquids such as water and breathing droplets. The middle layer of the main body is a melt-blown nonwoven fabric configured to block microorganisms and viruses, etc. The inner layer of the main body is a skin-friendly water-absorbing material configured to improve wearing comfort. However, the outer layer of the main body of the conventional mask has unsatisfactory waterproof effect, and cannot completely block off the microorganisms and viruses, and this will greatly increase the risk of infection.

The present invention is, therefore, arisen to obviate or at least mitigate the above-mentioned disadvantages.

### SUMMARY OF THE INVENTION

The main object of the present invention is to provide a mask with good effect of water repellent.

To achieve the above and other objects, a mask is provided, including: a main body, including a first outer layer, a second outer layer, a middle layer and an inner layer which are sequentially stacked in a thickness direction, the first outer layer and the second outer layer being nonwoven fabrics, the first outer layer including a plurality of first pressed portions, the second outer layer including a plurality of second pressed portion.

To achieve the above and other objects, a mask is further provided, including: a main body, including a first outer layer, a second outer layer, a middle layer and an inner layer which are sequentially stacked, the first outer layer and the second outer layer being nonwoven fabrics, the first outer layer and the second outer layer being in different colors.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a side view of a preferable embodiment of the present invention;

FIG. 4 is a partial enlargement of FIG. 3; and

FIG. 5 is a partial cross-sectional view of a preferable embodiment of the present invention.

### DETAILED DESCRIPTION OF THE PREFERRED EMBODIMENTS

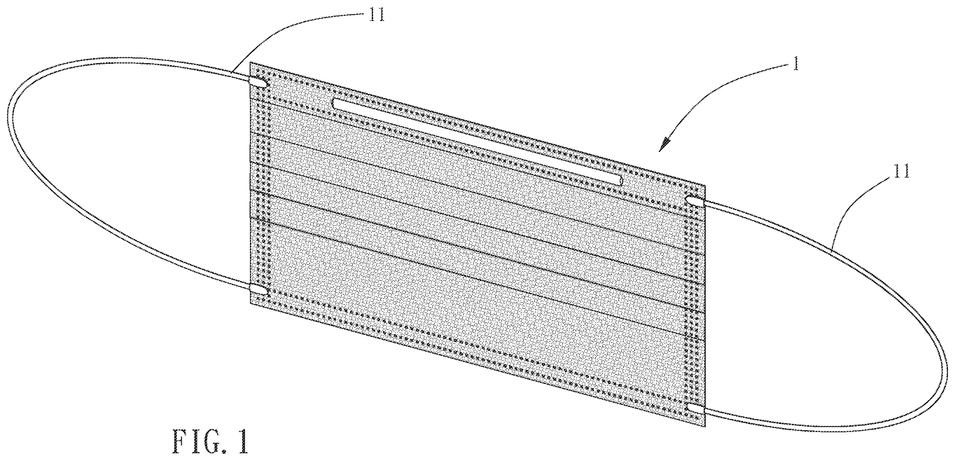

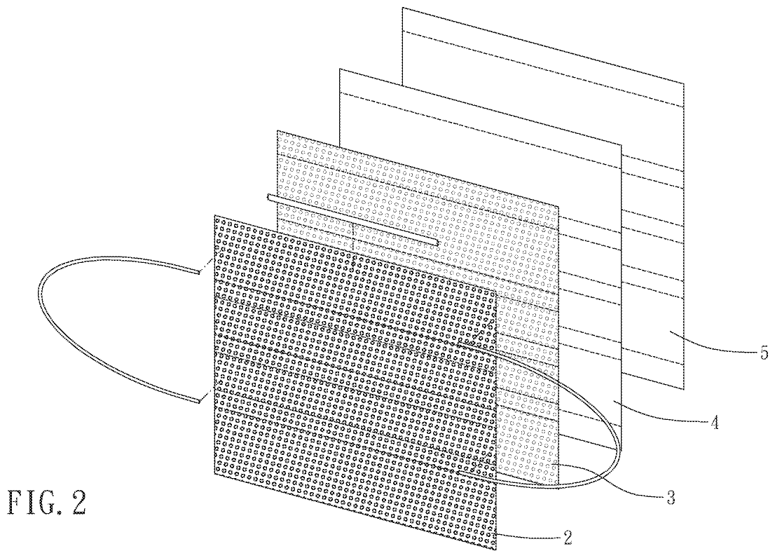

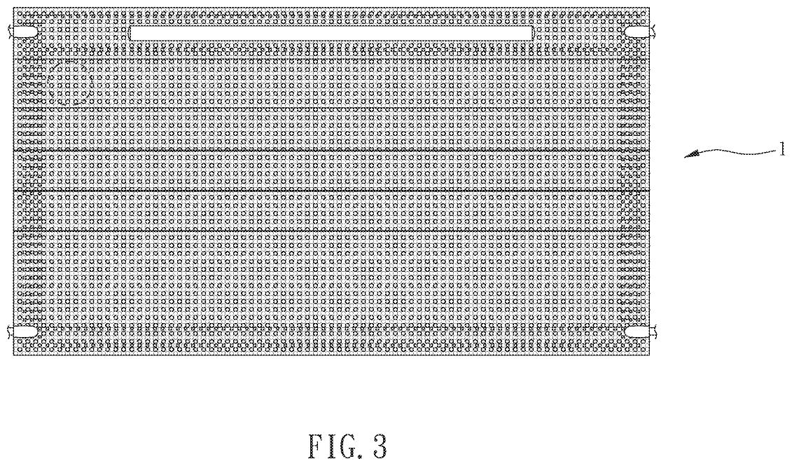

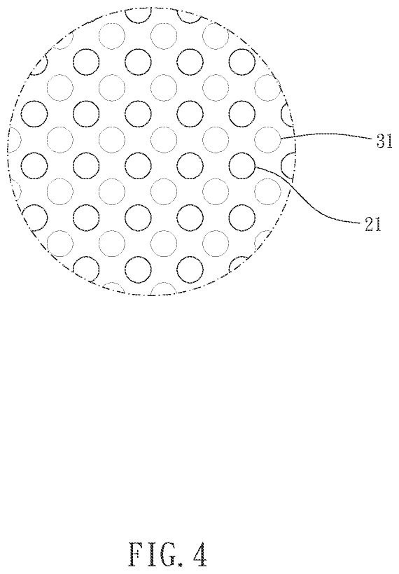

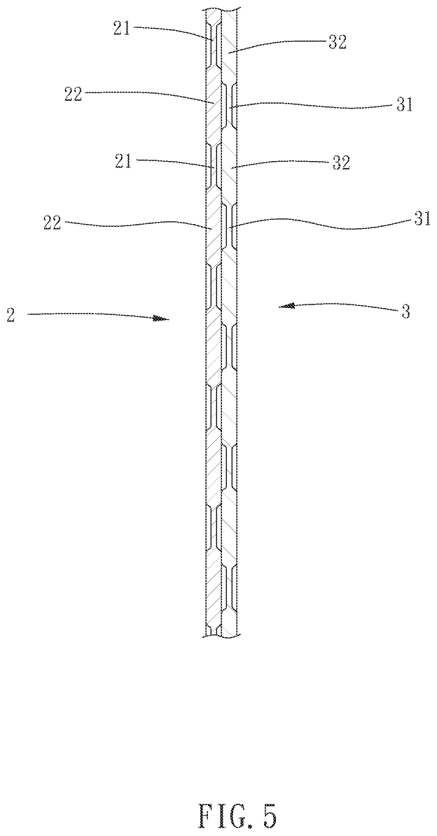

Please refer to FIGS. 1 to 5 for a preferable embodiment of the present invention. A mask 1 of the present invention includes a main body 1. The main body 1 includes a first outer layer 2, a second outer layer 3, a middle layer 4 and an inner layer 5 which are sequentially stacked in a thickness direction, the first outer layer 2 and the second outer layer 3 are nonwoven fabric, the first outer layer 2 includes a plurality of first pressed portions 21, and the second outer layer 3 includes a plurality of second pressed portions 31. The plurality of first pressed portions 21 and the plurality of second pressed portions 31 are configured for enhancing combination of the first outer layer 2 and the second outer layer 3. In this embodiment, the middle layer 4 is a melt-blown nonwoven fabric for blocking germs and viruses. By utilizing the first outer layer 2 and the second outer layer 3 stacked, it can effectively achieve the effect of water repellent and prevent liquid from penetrating into the middle layer 4. In this embodiment, the mask further includes two ear straps 11, and the two ear straps 11 are connected to opposing sides of the main body 1.

In this embodiment, the plurality of first pressed portions 21 and the plurality of second pressed portions 31 do not entirely overlap with each other. Since the plurality of first pressed portions 21 have the density higher than the density of rest portions of the first outer layer 2 and the plurality of second pressed portions 31 have the density higher than the density of rest portions of the second outer layer 3, it provides better effect of water repellent. Moreover, the plurality of first pressed portions 21 and the plurality of second pressed portions 31 which are alternatively arranged, which improves effect of water repellent of the rest portions of the first outer layer 2 and the second outer layer 3.

Specifically, the plurality of first pressed portions 21 and the plurality of second pressed portions 31 are respectively arranged in a matrix arrangement, and as viewed in the thickness direction, respective one of the plurality of first pressed portions 21 and respective one of the plurality of second pressed portions 31 are alternatively arranged so that the plurality of first pressed portions 21 respectively correspond to the rest portions (without the first pressed portions) of the second outer layer 3 in the thickness direction. Each of the plurality of first pressed portions 21 and each of the plurality of second pressed portions 31 may be circular or in other shapes.

The plurality of first pressed portions 21 are depressed from at least one side of the first outer layer 2 in the thickness direction; the plurality of second pressed portions 31 are depressed from at least one side of the second outer layer 3 in the thickness direction. In this embodiment, the plurality of first pressed portions 21 are depressed from respective sides of the first outer layer 2, and the plurality of second pressed portions 31 are depressed from respective sides of the second outer layer 3.

Specifically, between every adjacent two of the plurality of first pressed portions 21 of the first outer layer 2 is a first protruding portion 22, between every adjacent two of the plurality of second pressed portions 13 of the second outer layer 3 is a second protruding portion 32, each said first protruding portion 22 is abutted against one of the plurality of second pressed portions 31 in the thickness direction, and each said second protruding portion 32 is abutted against one of the plurality of first pressed portions 21 in the thickness direction, so that the plurality of first pressed portions 21 and the plurality of second pressed portions 31 overlap with each other, thus increasing contact area to prevent relative displacement of the first outer layer 2 and the second outer layer 3 between.

The first pressed portion 21 has a thickness between 0.25 to 0.5 times (preferably, 0.375 times) a thickness of the first protruding portion 22, and the second pressed portion 31 has a thickness between 0.25 to 0.5 times (preferably, 0.375 times) a thickness of the second protruding portion 32, so that the first outer layer 2 and the second outer layer 3 have sufficient thickness and structural strength.

Another mask is further provided. The mask includes a main body 1. The main body 1 includes a first outer layer 2, a second outer layer 3, a middle layer 4 and an inner layer 5 which are sequentially stacked. The first outer layer 2 and the second outer layer 3 are nonwoven fabrics, and the first outer layer 2 and the second outer layer 3 are in different colors. In this embodiment, each of the first outer layer 2 and the second outer layer 3 is a nonwoven fabric which is slightly light-penetrable. The first outer layer 2 and the second outer layer 3 are in different colors, which provides good identification and recognition for medical masks, surgical mask or the like.

The first outer layer 2 includes a plurality of first pressed portions 21, the second outer layer 3 includes a plurality of second pressed portions 31, the plurality of first pressed portions 21 and the plurality of second pressed portions 31 are respectively arranged in a matrix arrangement, and as viewed in the thickness direction, respective one of the plurality of first pressed portions 21 and respective one of the plurality of second pressed portions 31 are alternatively arranged. Preferably, each of the first outer layer 2 and the second outer layer 3 is a nonwoven fabric which is slightly light-penetrable, and thus it is easy to ascertain, by viewing through the first outer layer 2, whether the plurality of first pressed portions 21 and the plurality of second pressed portions 31 are well arranged in a matrix arrangement.

Since the first protruding portion 22 has a density smaller than a density of the first pressed portion 21 and the second protruding portion 32 has a density smaller than a density of the second pressed portion 31, the transmittance of the first protruding portion 22 is greater than the transmittance of the first pressed portion 21, the transmittance of the second protruding portion 32 is greater than the transmittance of the second pressed portion 31, and thus the plurality of first pressed portions 21 and the plurality of second pressed portions 31 can be recognized by eyes easily.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A mask, including:
a main body, including a first outer layer, a second outer layer, a middle layer and an inner layer which are sequentially stacked in a thickness direction, the first outer layer and the second outer layer being nonwoven fabrics, the first outer layer including a plurality of first pressed portions, the second outer layer including a plurality of second pressed portion.

2. The mask of claim 1, wherein the plurality of first pressed portions and the plurality of second pressed portions do not entirely overlap with each other.

3. The mask of claim 1, wherein the plurality of first pressed portions and the plurality of second pressed portions are respectively arranged in a matrix arrangement, and as viewed in the thickness direction, respective one of the plurality of first pressed portions and respective one of the plurality of second pressed portions are alternatively arranged.

4. The mask of claim 1, wherein the plurality of first pressed portions are depressed from at least one side of the first outer layer in the thickness direction; the plurality of second pressed portions are depressed from at least one side of the second outer layer in the thickness direction.

5. The mask of claim 4, wherein between every adjacent two of the plurality of first pressed portions of the first outer layer is a first protruding portion, between every adjacent two of the plurality of second pressed portions of the second outer layer is a second protruding portion, each said first protruding portion is abutted against one of the plurality of second pressed portions in the thickness direction, and each said second protruding portion is abutted against one of the plurality of first pressed portions in the thickness direction.

6. The mask of claim 2, wherein the plurality of first pressed portions and the plurality of second pressed portions are respectively arranged in a matrix arrangement, and as viewed in the thickness direction, respective one of the plurality of first pressed portions and respective one of the plurality of second pressed portions are alternatively arranged; the plurality of first pressed portions are depressed from at least one side of the first outer layer in the thickness direction; the plurality of second pressed portions are depressed from at least one side of the second outer layer in the thickness direction; between every adjacent two of the plurality of first pressed portions of the first outer layer is a first protruding portion, between every adjacent two of the plurality of second pressed portions of the second outer layer is a second protruding portion, each said first protruding portion is abutted against one of the plurality of second pressed portions in the thickness direction, and each said second protruding portion is abutted against one of the plurality of first pressed portions in the thickness direction; the first pressed portion has a thickness between 0.25 to 0.5 times a thickness of the first protruding portion, and the second pressed portion has a thickness between 0.25 to 0.5 times a thickness of the second protruding portion; the mask further includes two ear straps, the two ear straps are connected to opposing sides of the main body, respectively; each of the plurality of first pressed portions and each of the plurality of second pressed portions are circular.

7. A mask, including:
a main body, including a first outer layer, a second outer layer, a middle layer and an inner layer which are sequentially stacked, the first outer layer and the second outer layer being nonwoven fabrics, the first outer layer and the second outer layer being in different colors.

8. The mask of claim 7, wherein each of the first outer layer and the second outer layer is a nonwoven fabric which is slightly light-penetrable.

9. The mask of claim 7, wherein the first outer layer includes a plurality of first pressed portions, the second outer layer includes a plurality of second pressed portion, the plurality of first pressed portions and the plurality of second pressed portions are respectively arranged in a matrix arrangement, and as viewed in the thickness direction, respective one of the plurality of first pressed portions and respective one of the plurality of second pressed portions are alternatively arranged.

10. The mask of claim 9, wherein between every adjacent two of the plurality of first pressed portions of the first outer layer is a first protruding portion, between every adjacent two of the plurality of second pressed portions of the second outer layer is a second protruding portion, each said first protruding portion is abutted against one of the plurality of second pressed portions in the thickness direction, and each said second protruding portion is abutted against one of the plurality of first pressed portions in the thickness direction; the first pressed portion has a thickness between 0.25 to 0.5 times a thickness of the first protruding portion, and the second pressed portion has a thickness between 0.25 to 0.5 times a thickness of the second protruding portion; the mask further includes two ear straps, the two ear straps are connected to opposing sides of the main body, respectively; the transmittance of the first protruding portion is greater than the transmittance of the first pressed portion, and the transmittance of the second protruding portion is greater than the transmittance of the second pressed portion.
